(19) United States
(12) Patent Application Publication
(10) Pub. No.: US 2023/0368168 A1
(43) Pub. Date: Nov. 16, 2023

(54) METHOD FOR CREATING NON-FUNGIBLE TOKENS

(71) Applicant: Kyou Sang OH, Anyang-si (KR)

(72) Inventor: Kyou Sang OH, Anyang-si (KR)

(21) Appl. No.: 18/317,215

(22) Filed: May 15, 2023

Related U.S. Application Data
(60) Provisional application No. 63/342,084, filed on May 14, 2022.

(51) Int. Cl. G06Q 20/12; G06Q 20/06; G06Q 30/0208; G06Q 20/36

(52) U.S. Cl. CPC G06Q 20/1235; G06Q 20/065; G06Q 30/0208; G06Q 20/367; G06Q 2220/00

(57) ABSTRACT

A method for creating non-fungible tokens includes providing a marketplace to allow users to obtain a first-stage non-fungible token (NFT); providing the marketplace to allow the users to obtain a second-stage NFT, wherein obtaining the second-stage NFT requires two or more first-stage NFTs and a predetermined amount of cryptocurrency; providing the marketplace to allow the users to obtain a third-stage NFT, wherein obtaining the third-stage NFT requires one or more second-stage NFTs and a predetermined amount of cryptocurrency; and providing a reward to the users having the third-stage NFT.

### CROSS-REFERENCE TO RELATED APPLICATION(S)

This application claims priority from Provisional Application No. 63/342,084 filed on May 14, 2022, which is incorporated herein by reference in its entirety.

### TECHNICAL FIELD

The present disclosure relates to a method for creating non-fungible tokens (NFTs), and more particularly, to a method for promoting more lively creation of the NFTs based on gamification and reward by cryptocurrency. The present disclosure also relates to a method of providing a marketplace for users to create and trade NFTs.

### RELATED ART

A non-fungible token (NFT) is a blockchain-based token that is associated with a unique asset such as an artwork, a document, or multimedia content. The need to guarantee the rights of digital content have been existed for a long time, and NFTs based on blockchain technology are considered a viable solution to satisfy these needs. In addition, due to the recent advance in the transaction speed, transaction cost, and safe file management of digital content, the blockchain-based technologies and related applications are rapidly developing.

Accordingly, the NFT, which has been traditionally recognized as the realm of digital art, is now entering our daily lives by seeking to combine it with real-life products. Decentralization, immutability, and transparency of the blockchain are making the NFT applications to expand from the financial sector to more various areas such as healthcare, government works, real estate, and logistics, thereby disrupting the traditional systems.

### SUMMARY

The present disclosure provides a complete business model that combines real assets and blockchain technology based on a decentralized platform. Through the gamification of the virtual economy, the NFTs created and distributed according to embodiments of the present disclosure can provide values that are far more than as mere currency.

Further, according to the subject matter of the present disclosure, more creative NFTs may be facilitated by rewarding the creators with economic advantages (e.g., by awarding cryptocurrency), exclusive rights (e.g., copyrights) to reproduce, adapt, publish, perform, and/or display the artworks, and opportunities to contribute to the community and society.

An aspect of the present disclosure may provide a method of creating non-fungible tokens (NFTs). The method may include providing a marketplace to allow users to obtain a first-stage NFT, providing the marketplace to allow the users to obtain a second-stage NFT, providing the marketplace to allow the users to obtain a third-stage NFT, and providing a reward to the users having the third-stage NFT. Obtaining the second-stage NFT may require two or more first-stage NFTs and a predetermined amount of cryptocurrency. Obtaining the third-stage NFT may require one or more second-stage NFTs and a predetermined amount of cryptocurrency.

In some embodiments, the reward may include an option to purchase a real-life item, a right to mine cryptocurrency, a copyright for an artwork, a right to exhibit the artwork, and any combination thereof.

In some embodiments, the first-stage NFT may include a type1-1, a type1-2, and a type1-3. In pure blood lineage, the second-stage NFT may include a type2-1 obtained by combining the type1-1 and the type1-1, a type2-2 obtained by combining the type1-2 and the type1-2, and a type2-3 obtained by combining the type1-3 and the type1-3. Further, the mixed blood second-stage NFT may include a type2-4 obtained by combining the type1-1 and the type1-2, a type2-5 obtained by combining the type1-1 and the type1-3, and a type2-6 obtained by combining the type1-2 and the type1-3.

In some embodiments, the pure blood third-stage NFT may include a type3-1 obtained based on the type2-1, a type3-2 obtained based on the type2-2, and a type3-3 obtained based on the type2-3. Further, the mixed blood third-stage NFT may include a type3-4 obtained based on the type2-4, a type3-5 obtained based on the type2-5, and a type3-6 obtained based on the type2-6. The mixed blood third-stage NFT may also include a type3-7 obtained by combining the type2-4 and the type2-5, a type3-8 obtained by combining the type2-4 and the type2-6, and a type3-9 obtained by combining the type2-5 and the type2-6.

In some embodiments, the mixed blood third-stage NFT may further include a type3-10 obtained by combining the type2-1 and the type2-4, a type3-11 obtained by combining the type2-1 and the type2-5, a type3-12 obtained by combining the type2-1 and the type2-6, a type3-13 obtained by combining the type2-2 and the type2-4, a type3-14 obtained by combining the type2-2 and the type2-5, a type3-15 obtained by combining the type2-2 and the type2-6, a type3-16 obtained by combining the type2-3 and the type2-4, a type3-17 obtained by combining the type2-3 and the type2-5, and a type3-18 obtained by combining the type2-3 and the type2-6.

In some embodiments, the mutated blood third-stage NFT may include a type3-19 obtained by combining the type2-1 and an NFT from a partnering service, a type3-20 obtained by combining the type2-2 and an NFT from a partnering service, and a type3-21 obtained by combining the type2-3 and an NFT from a partnering service.

The type1-1, the type1-2, and the type1-3 may be issued in different proportions.

According to a related aspect of the present disclosure, a non-transitory computer readable medium containing program instructions executed by a processor or controller is provided. The program instructions when executed by the processor or controller may be configured to provide a marketplace to allow users to obtain a first-stage non-fungible token (NFT), provide the marketplace to allow the users to obtain a second-stage NFT, wherein obtaining the second-stage NFT requires two or more first-stage NFTs and a predetermined amount of cryptocurrency, provide the marketplace to allow the users to obtain a third-stage NFT, wherein obtaining the third-stage NFT requires one or more second-stage NFTs and a predetermined amount of cryptocurrency, and provide a reward to the users having the third-stage NFT.

### BRIEF DESCRIPTION OF THE DRAWINGS

A brief description of each drawing is provided to more sufficiently understand drawings used in the detailed description of the present disclosure.

FIG. 1 shows a schematic of the three stage NFT creation according to an embodiment of the present disclosure;

FIG. 2 depicts creating pure blood second-stage NFTs according to an embodiment of the present disclosure;

FIG. 3 depicts creating mixed blood second-stage NFTs according to an embodiment of the present disclosure;

FIG. 4 depicts the lineage of the pure blood NFTs according to an embodiment of the present disclosure;

FIG. 5 depicts the lineage of the mixed blood NFTs where the mixed blood occurs at the second stage according to an embodiment of the present disclosure;

FIG. 6 depicts the lineage of the mixed blood NFTs, where the mixed blood occurs at the third stage between two mixed blood second-stage NFTs according to an embodiment of the present disclosure;

FIGS. 7A-7C depict the lineage of the mixed blood NFTs, where the mixed blood occurs at the third stage between a pure blood second-stage NFT and a mixed blood second-stage NFT according to an embodiment of the present disclosure; and

FIG. 8 depicts creating mutated blood third-stage NFTs according to an embodiment of the present disclosure.

It should be understood that the above-referenced drawings are not necessarily to scale, presenting a somewhat simplified representation of various features illustrative of the basic principles of the disclosure. The specific design features of the present disclosure, including, for example, specific dimensions, orientations, locations, shapes, and manufacturing steps, will be determined in part by the particular intended application and use environment.

### DETAILED DESCRIPTION

Advantages and features of the present disclosure and a method of achieving the same will become apparent with reference to the accompanying drawings and exemplary embodiments described below in detail. However, the present disclosure is not limited to the exemplary embodiments described herein and may be embodied in variations and modifications. The exemplary embodiments are provided merely to allow one of ordinary skill in the art to understand the scope of the present disclosure, which will be defined by the scope of the claims. Accordingly, in some embodiments, well-known operations of a process, well-known structures, and well-known technologies will not be described in detail to avoid obscuring the disclosure. Throughout the specification, same reference numerals refer to same elements.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinbelow, a method of operating a platform for trading non-fungible tokens (NFTs) will be discussed in detail in reference to the appended drawings.

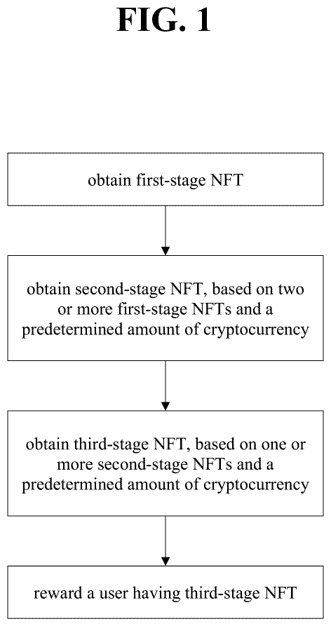

Referring to FIG. 1, a method of operating a platform for trading NFTs may include three stages, namely, a first stage, a second stage, and a third stage. During each stage, users may trade and/or create NFTs, and the service provider may maintain services, regulate, and/or provide governance over the users' transactions.

In the first stage, the users may obtain a first-stage NFT. In some embodiments, the first-stage NFT may include three different types, namely, a type1-1, a type1-2, and a type1-3. Herein, the type1-1, the type1-2, and the type1-3 NFTs may also be referred to as Normal Penbo, Rare Penbo, and Super Rare Penbo, respectively. As the names suggest, the different types of NFTs may be minted in different proportions. By way of example, Normal Penbo may be issued in 90%, Rare Penbo may be issued in 9%, and Super Rare Penbo may be issued in 1% of the total NFTs minted at a particular session. The proportions of each type may be variously adjusted. Different types of first-stage NFTs may be associated with different amount of cryptocurrency to acquire.

In the second stage, the users may obtain a second-stage NFT. More specifically, the second-stage NFT may be obtained by combining two first-stage NFTs. In some embodiments, a predetermined amount of cryptocurrency may be required in addition to the two first-stage NFTs to create the second-stage NFT. From the second stage, the NFTs may be categorized into a pure blood, a mixed blood, and a mutated blood.

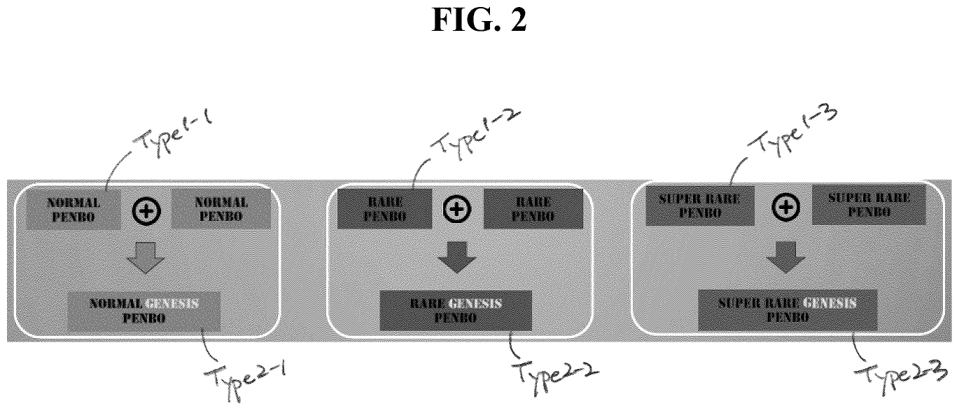

In some embodiments, the pure blood second-stage NFT may be created by combining two first-stage NFTs of the same type, as shown in FIG. 2. For example, a type2-1 may be obtained by combining the type1-1 and the type1-1, a type2-2 may be obtained by combining the type1-2 and the type1-2, and a type2-3 may be obtained by combining the type1-3 and the type1-3. Herein, the second-stage NFT may also be referred to as Genesis Penbo. Accordingly, the type2-1, the type2-2, and the type2-3 NFTs may also be referred to as Normal Genesis Penbo, Rare Genesis Penbo, Super Rare Genesis Penbo, respectively.

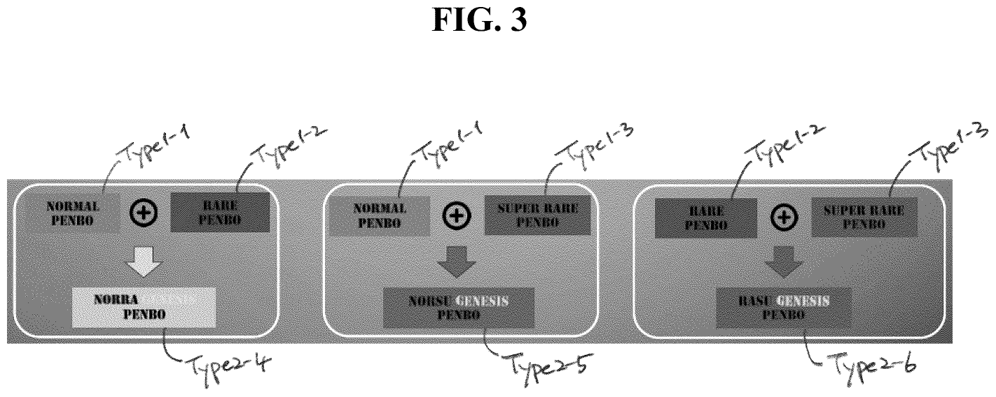

The mixed blood second-stage NFT may also be created by combining two first-stage NFTs of different types, as shown in FIG. 3. For example, a type2-4 may be obtained by combining the type1-1 and the type1-2, a type2-5 may be obtained by combining the type1-1 and the type1-3, and a type2-6 obtained by combining the type1-2 and the type1-3. Herein, the type2-4, the type2-5, and the type2-6 NFTs may also be referred to as Norra Genesis Penbo, Norsu Genesis Penbo, and Rasu Genesis Penbo, respectively.

In the third stage, the users may obtain a third-stage NFT by combining two second-stage NFTs. In some embodiments, a predetermined amount of cryptocurrency may be required to create the third-stage NFT, in addition to the two second-stage NFTs. Herein, the third-stage NFT may also be referred to as Nirvana Penbo.

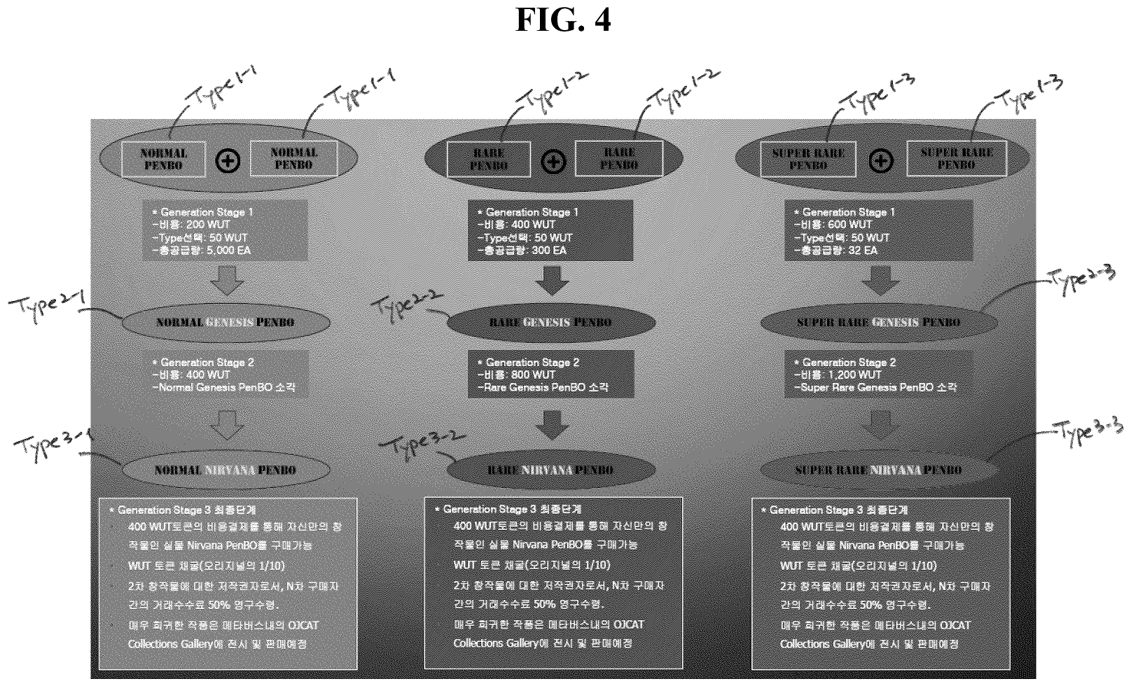

Referring to FIG. 4, along the pure bloodline, the third-stage NFT may be obtained based on the pure blood second-stage NFTs. As such, the third-stage NFT may include a type3-1 obtained based on the type2-1, a type3-2 obtained based on the type2-2, and a type3-3 obtained based on the type2-3. Herein, the type3-1, the type3-2, and the type3-3 NFTs may also be referred to as Normal Nirvana Penbo, Rare Nirvana Penbo, and Super Rare Nirvana Penbo, respectively.

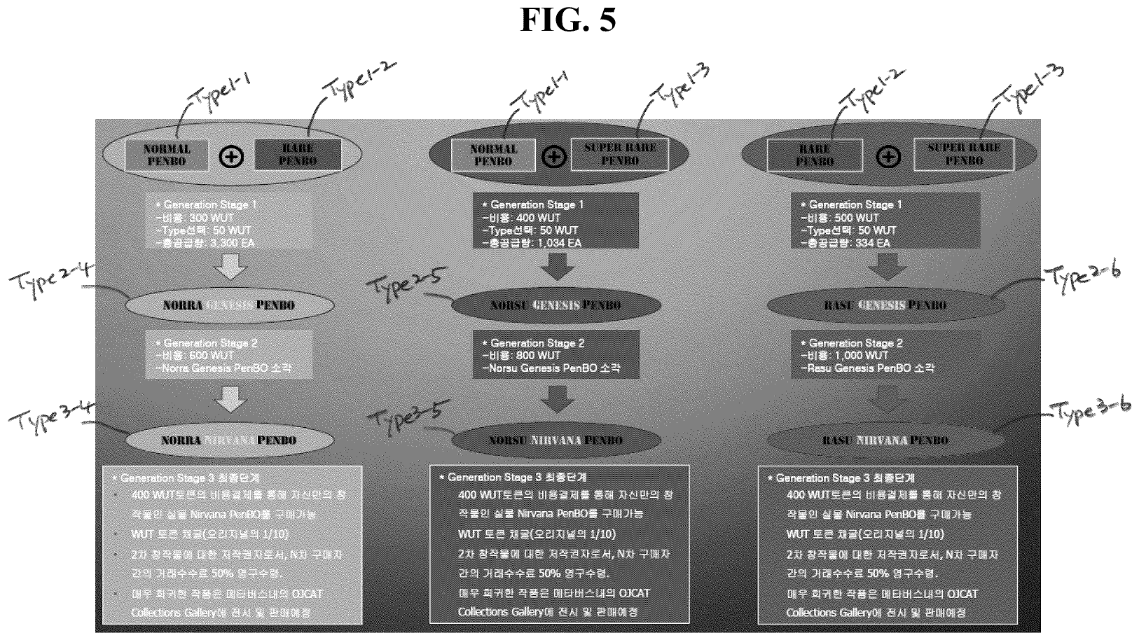

Referring to FIG. 5, along the mixed blood line, the third-stage NFT may be obtained based on the mixed blood second-stage NFTs. As such, the third-stage NFT may include a type3-4 obtained based on the type2-4, a type3-5 obtained based on the type2-5, and a type3-6 obtained based on the type2-6. Herein, the type3-4, the type3-5, and the type3-6 NFTs may also be referred to as Norra Nirvana Penbo, Norsu Nirvana Penbo, and Rasu Nirvana Penbo, respectively.

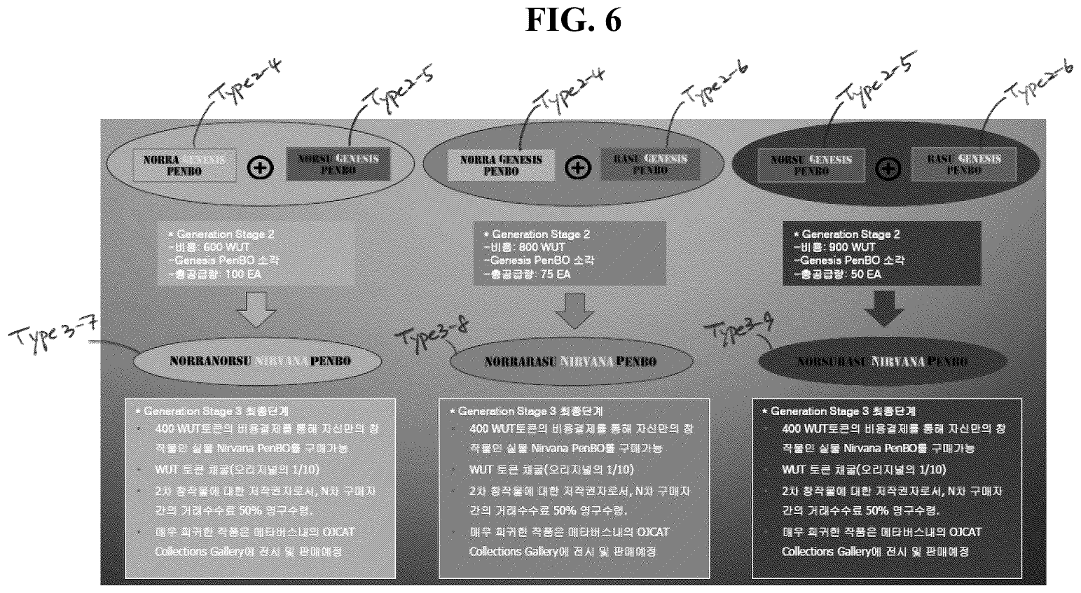

In some embodiments, as shown in FIG. 6, the mixed blood third-stage NFT may also be created by combining two different types of mixed blood second-stage NFTs. For example, the third-stage NFT may include a type3-7 obtained by combining the type2-4 and the type2-5, a type3-8 obtained by combining the type2-4 and the type2-6, and a type3-9 obtained by combining the type2-5 and the type2-6. Herein, the type3-7, the type3-8, and the type3-9 NFTs may also be referred to as Norrallorsu Nirvana Penbo, NorraRasu Nirvana Penbo, and NorsuRasu Nirvana Penbo, respectively.

Likewise, the third-stage NFT may be obtained by combining a pure blood second-stage NFT and a mixed blood second-stage NFT.

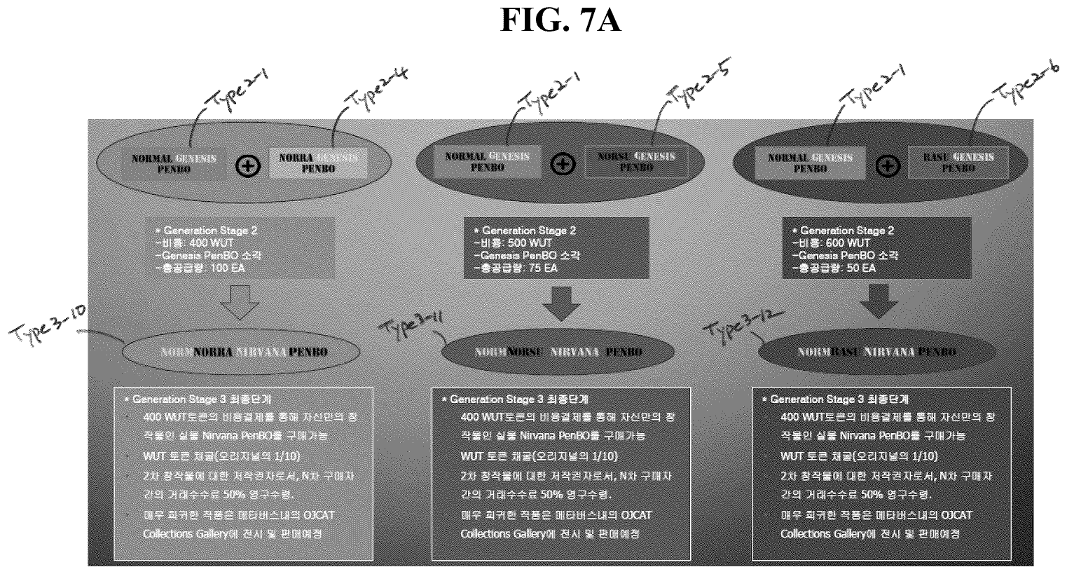

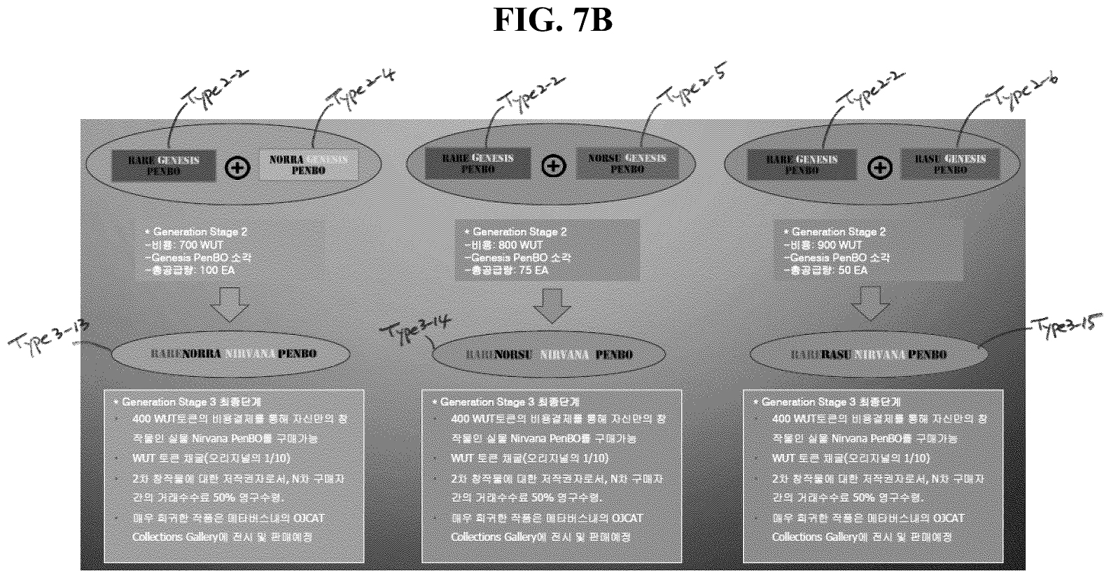

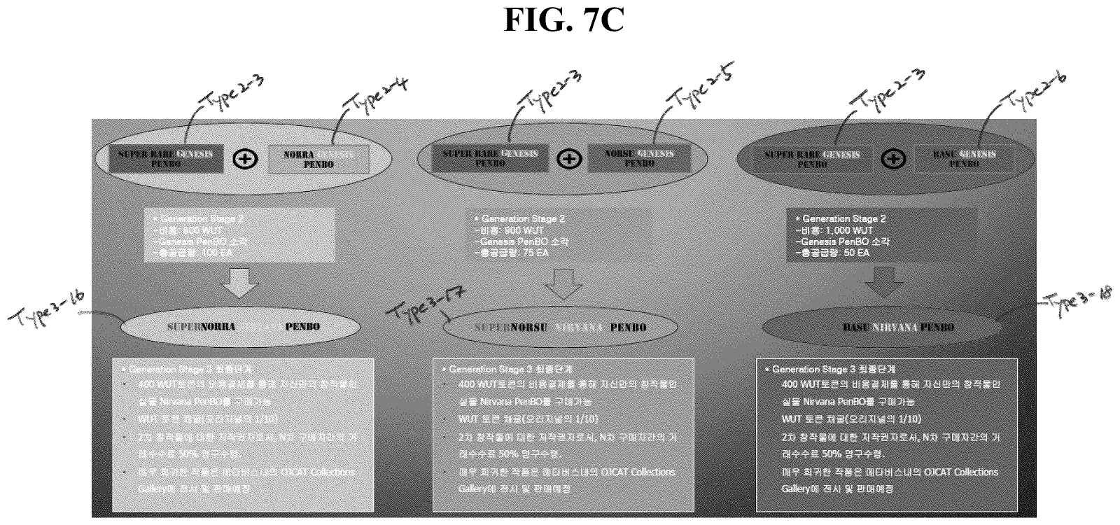

As such, the third-stage NFT may include a type3-10 obtained by combining the type2-1 and the type2-4, a type3-11 obtained by combining the type2-1 and the type2-5, and a type3-12 obtained by combining the type2-1 and the type2-6, as shown in FIG. 7A. Further, as shown in FIG. 7B, the third-stage NFT may include a type3-13 obtained by combining the type2-2 and the type2-4, a type3-14 obtained by combining the type2-2 and the type2-5, and a type3-15 obtained by combining the type2-2 and the type2-6. The third-stage NFT may also include a type3-16 obtained by combining the type2-3 and the type2-4, a type3-17 obtained by combining the type2-3 and the type2-5, and a type3-18 obtained by combining the type2-3 and the type2-6, as shown in FIG. 7C. Herein, the type3-10, the type3-11, the type3-12, the type3-13, the type3-14, the type3-15, the type3-16, the type3-17, and the type3-18 NFTs may also be referred to as NormNorra Nirvana Penbo, NormNorsu Nirvana Penbo, NormRasu Nirvana Penbo, RareNorra Nirvana Penbo, RareNorsu Nirvana Penbo, RareRasu Nirvana Penbo, SuperNorra Nirvana Penbo, SuperNorsu Nirvana Penbo, and SuperRasu Nirvana Penbo, respectively.

For any user having a third-stage NFT, the service provider may provide a reward to the user. In some embodiments, the reward may include an option to purchase a real-life item, a right to mine cryptocurrency, a copyright for an artwork, a right to exhibit the artwork in the metaverse, and any combination thereof.

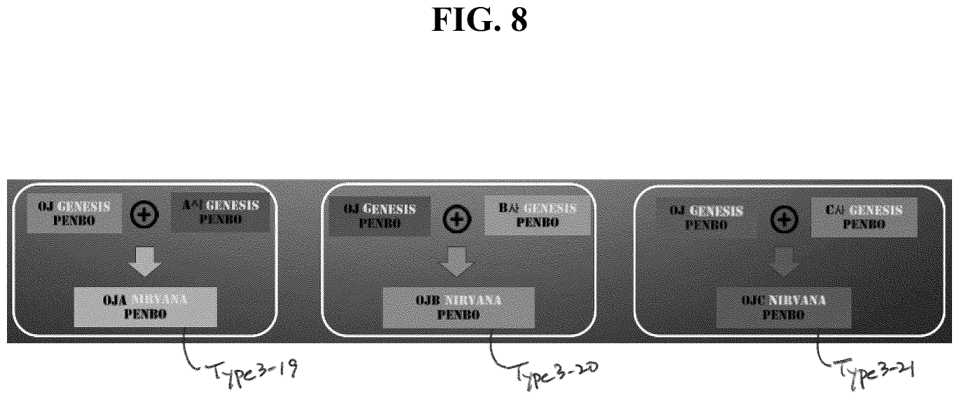

Further, referring to FIG. 8, the mutated blood second-stage NFT may be created by combing any one of the second-stage NFTs and an NFT from a partnering service. For example, a type3-19 may be obtained by combining the type2-1 and an NFT from a partnering service, a type3-20 may be obtained by combining the type2-2 and an NFT from a partnering service, and a type3-21 may obtained by combining the type3-3 and an NFT from a partnering service. However, the present disclosure is not limited thereto, and the mutated blood second-stage NFT may be created by combining any other second-stage NFT with an NFT from any partnering services.

In each embodiment, after the next stage NFT has been created, the previous stage NFTs that have been used may be destroyed.

Further, in some embodiments, each NFT may be represented by a unique color assigned to each type.

Control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Further, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Hereinabove, although the present disclosure is described by specific matters such as concrete components, and the like, the exemplary embodiments and the drawings are provided merely for assisting in the entire understanding of the present disclosure. Therefore, the present disclosure is not limited to the exemplary embodiments described herein. Various modifications and changes can be made by a person of ordinary skill in the art to which the present disclosure pertains. The spirit of the present disclosure should not be limited to the above-described exemplary embodiments, and the following claims as well as all technical spirits modified equally or equivalently to the claims should be interpreted to fall within the scope and spirit of the disclosure.

What is claimed is:

1. A method comprising:
providing a marketplace to allow users to obtain a first-stage non-fungible token (NFT);
providing the marketplace to allow the users to obtain a second-stage NFT, wherein obtaining the second-stage NFT requires two or more first-stage NFTs and a predetermined amount of cryptocurrency;
providing the marketplace to allow the users to obtain a third-stage NFT, wherein obtaining the third-stage NFT requires one or more second-stage NFTs and a predetermined amount of cryptocurrency; and
providing a reward to the users having the third-stage NFT.

2. The method of claim 1, wherein the reward includes one or more selected from the group consisting of an option to purchase a real-life item, a right to mine cryptocurrency, a copyright for an artwork, and a right to exhibit the artwork.

3. The method of claim 1, wherein the first-stage NFT comprises a type1-1, a type1-2, and a type1-3.

4. The method of claim 1, wherein the second-stage NFT comprises:
a type2-1 obtained by combining the type1-1 and the type1-1;
a type2-2 obtained by combining the type1-2 and the type1-2; and
a type2-3 obtained by combining the type1-3 and the type1-3.

5. The method of claim 4, wherein the second-stage NFT further comprises:
a type2-4 obtained by combining the type1-1 and the type1-2;
a type2-5 obtained by combining the type1-1 and the type1-3; and
a type2-6 obtained by combining the type1-2 and the type1-3.

6. The method of claim 5, wherein the third-stage NFT comprises:
a type3-1 obtained based on the type2-1;
a type3-2 obtained based on the type2-2; and
a type3-3 obtained based on the type2-3.

7. The method of claim 6, wherein the third-stage NFT further comprises:
a type3-4 obtained based on the type2-4;
a type3-5 obtained based on the type2-5; and
a type3-6 obtained based on the type2-6.

8. The method of claim 7, wherein the third-stage NFT further comprises:
a type3-7 obtained by combining the type2-4 and the type2-5;
a type3-8 obtained by combining the type2-4 and the type2-6; and
a type3-9 obtained by combining the type2-5 and the type2-6.

9. The method of claim 8, wherein the third-stage NFT further comprises:
a type3-10 obtained by combining the type2-1 and the type2-4;
a type3-11 obtained by combining the type2-1 and the type2-5;
a type3-12 obtained by combining the type2-1 and the type2-6;
a type3-13 obtained by combining the type2-2 and the type2-4;
a type3-14 obtained by combining the type2-2 and the type2-5;
a type3-15 obtained by combining the type2-2 and the type2-6;
a type3-16 obtained by combining the type2-3 and the type2-4;
a type3-17 obtained by combining the type2-3 and the type2-5; and
a type3-18 obtained by combining the type2-3 and the type2-6.

10. The method of claim 9, wherein the third-stage NFT further comprises:
a type3-19 obtained by combining the type2-1 and an NFT from a partnering service;
a type3-20 obtained by combining the type2-2 and an NFT from a partnering service; and
a type3-21 obtained by combining the type2-3 and an NFT from a partnering service.

11. The method of claim 3, wherein the type1-1, the type1-2, and the type1-3 are issued in different proportions.

12. A non-transitory computer readable medium containing program instructions executed by a processor or controller, the program instructions when executed by the processor or controller configured to:
provide a marketplace to allow users to obtain a first-stage non-fungible token (NFT);
provide the marketplace to allow the users to obtain a second-stage NFT, wherein obtaining the second-stage NFT requires two or more first-stage NFTs and a predetermined amount of cryptocurrency;
provide the marketplace to allow the users to obtain a third-stage NFT, wherein obtaining the third-stage NFT requires one or more second-stage NFTs and a predetermined amount of cryptocurrency; and
provide a reward to the users having the third-stage NFT.
